(19) United States
(12) Patent Application Publication
(10) Pub. No.: US 2005/0273389 A1
(43) Pub. Date: Dec. 8, 2005

(54) Multi-platform advertisement system

(75) Inventors: Travis J. Worthington, Kansas City, GA (US); Kristen Joseph Isaac, Mableton, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Stretch Radio Incorporated, Atlanta, GA (US)

(21) Appl. No.: 11/143,423

(22) Filed: Jun. 2, 2005

Related U.S. Application Data
(60) Provisional application No. 60/576,211, filed on Jun. 2, 2004.

(51) Int. Cl. G06F 17/60

(52) U.S. Cl. 705/14

(57) ABSTRACT

A three-part system comprising content delivered via television, the Internet, and live performances as vehicles to spread an advertisement message by an artist or entertainer that is associated or affiliated with a corporation or other entity. Each of the components promotes the other component in order to strengthen the overall methodology. By using a variety of techniques, the advertising generated by the system is broad in scope, measurable, able to target market specific groups, and is self-sustaining. Using and providing exclusive content through one or more of the advertising channels further drives demand and enhances the marketing value of the system.

This application claims the benefit, pursuant to 35 U.S.C. §119(e), of U.S. Provisional Patent Application entitled “ONLINE MULTIMEDIA ADVERTISEMENT SYSTEM,” filed on Jun. 2, 2004, and assigned Ser. No. 60/576,211, the disclosure of which is incorporated herein by reference in its entirety.

### BACKGROUND OF THE INVENTION

Television commercials have been a staple of advertising for over 60 years. During that time, they were the most effective medium for companies to utilize in order to advertise their messages to consumers. However, the advertising landscape is changing. Currently, a multitude of technologies and devices are capturing the attention of consumers. One such product is the Digital Video Recorder (DVR). DVRs allow consumer to choose when they watch their shows; but the feature troubling to advertisers is that DVRs can quickly fast-forward through commercial advertisements. The result is a lower return on investment from TV advertisements.

Further, there is another factor weakening the effectiveness of television advertising. The power of commercials to reach an audience is based on the existence of programs that appeal to a variety of consumers. Television has not been able to maintain the attention of all groups. As a result, corporations are looking for a strategy that will replace TV as a capable means of advertising.

The above-mentioned examples show that advertising campaigns today share something with traditional advertising efforts: they have limited reach. Long standing methods of promotion, like commercials and print, are not very flexible. An advertisement made for television only works well in that medium. The same is true for printed ads. A piece made for a magazine will look flat and possibly illegible on screen. A more global perspective reveals that this problem becomes increasingly complicated as technology and potential advertising space shifts to handheld devices. Traditional media is not in a format that is widely read by new technology. It also does not accommodate the screen sizes, bandwidth limits, and storage capacity associated with these instruments. That does not project continued success for the old approaches of advertising.

It would seem reasonable that the current programs being developed would be prepared to take full advantage of the old and new opportunities for advertisement promotions. The reality is that advertising agencies are creating programs that generally exploit one new marketing technique and use few others as support for that technique. This is an outgrowth of old practices and shows that advertisers do not have a clear, broad understanding of where marketing is going.

Therefore, there is a need for an advertising solution that extends the reach of traditional advertising and is compatible with new and emerging promotional technologies. Such a system must look beyond television and print as the final media and be compatible with devices that execute digital formats. The form of the media is not the primary determining factor; the message must also be told differently in order to affect a world of educated consumers whose attention is divided between many new platforms.

### SUMMARY OF THE INVENTION

The present invention relates to a novel method for marketing across a plurality of platforms. The focus of this approach is to provide an effective way to promote a company's or individual's brand while continuing to utilize traditional advertising techniques as a part of the overall system. This system pairs a company and an artist or entertainer—preferably a musical artist or entertainer—in a mutually beneficial partnership. The system bridges traditional advertisement methods and develops media for new marketing opportunities including the growing digital device market.

The invention includes a three-part approach that comprises content delivered via television, the Internet, and live performances, all as vehicles to spread an advertisement message. Each of the components of the invention promotes the other component in order to strengthen the overall marketing system. By using a variety of techniques, the advertising generated by the present system is broad in scope, measurable, able to target market-specific groups, and is self-sustaining. The process remains streamlined, easy to manage, and affordable.

An aspect of the present invention comprises a method for associating parties for an advertising relationship by a central agency. The method comprises the steps of determining a first party to an advertising relationship and thereafter identifying a plurality of potential second parties to the advertising relationship. A second party to an advertising relationship is determined from the plurality of potential second parties.

The method further comprises the steps of associating the first party with at least one of the potential second parties. Further, the second party creates a plurality of multimedia content, wherein the multimedia content created by the second party is associated with the first party. Lastly, the associated multimedia content is distributed. The multimedia content preferably comprises an audio or video recording of a performance by the second party.

Within aspects of the present invention the step of distributing the multimedia content comprises utilizing the multimedia content in a television advertisement that is associated with the first party. The step of distributing the multimedia content also comprises distributing the multimedia content via an interactive website that is associated with the first party and the second party through a joint or co-branded website. Further, the interactive website preferably comprises a downloadable multimedia player, the downloadable multimedia player being associated with the first party, wherein the multimedia content created by the second party is configured to be played back exclusively on the downloadable multimedia player that is associated with the first party and only available at the co-branded website. Other aspects call for the multimedia content to be streamed to the downloadable multimedia player. The step of distributing the multimedia content also comprises the step of the second party performing the content of the exclusive multimedia content in a live performance.

A further aspect of the present invention comprises a method for associating parties for an advertising relationship by a central agency, wherein the method comprises the steps of determining a first party to an advertising relationship, identifying a plurality of potential second parties and determining a second party to an advertising relationship from a plurality of potential second parties. The method further comprises the steps of associating the first party with at least one of the potential second parties, wherein the second party creates a plurality of multimedia content, the multimedia content comprising audio and video multimedia content. The multimedia content created by the second party is associated with the first party and thereafter the associated multimedia content is distributed.

Aspects of the present invention provide distributing the multimedia content by utilizing the multimedia content in a television advertisement that is associated with the first party. Further aspects provide for distributing the multimedia content via an interactive website that is associated with the first party and the second party. The interactive website preferably comprises a downloadable multimedia player, wherein the downloadable multimedia player is associated with the first party. The multimedia content created by the second party is configured to be streamed and played back exclusively on the downloadable multimedia player that is associated with the first party. Also, the interactive website is preferably accessible via a wireless or similar handheld or portable devices. Within additional aspects of the present invention the step of distributing the multimedia content comprises the step of the second party performing the content of the multimedia content in a live performance.

A yet further aspect of the present invention comprises a method for associating parties for an advertising relationship by a central agency. The method comprises the steps of determining a first party to an advertising relationship and thereafter identifying a plurality of potential second parties to the advertising relationship. A listing of the plurality of potential second parties is thereafter compiled and maintained in a database, from there a second party to an advertising relationship is determined from the listing of the plurality of potential second parties.

The method further comprises the steps of associating the first party with at least one of the potential second parties. Further, the second party creates a plurality of multimedia content, wherein the multimedia content created by the second party is associated with the first party. Lastly, the associated multimedia content is distributed. The multimedia content comprises an audio or video recording of a performance by the second party.

### DETAILED DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

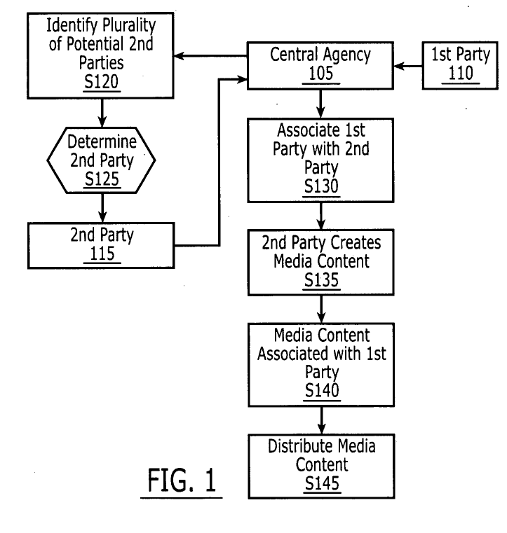

FIG. 1 is a flow diagram illustrating a method that can be utilized with aspects of the present invention.

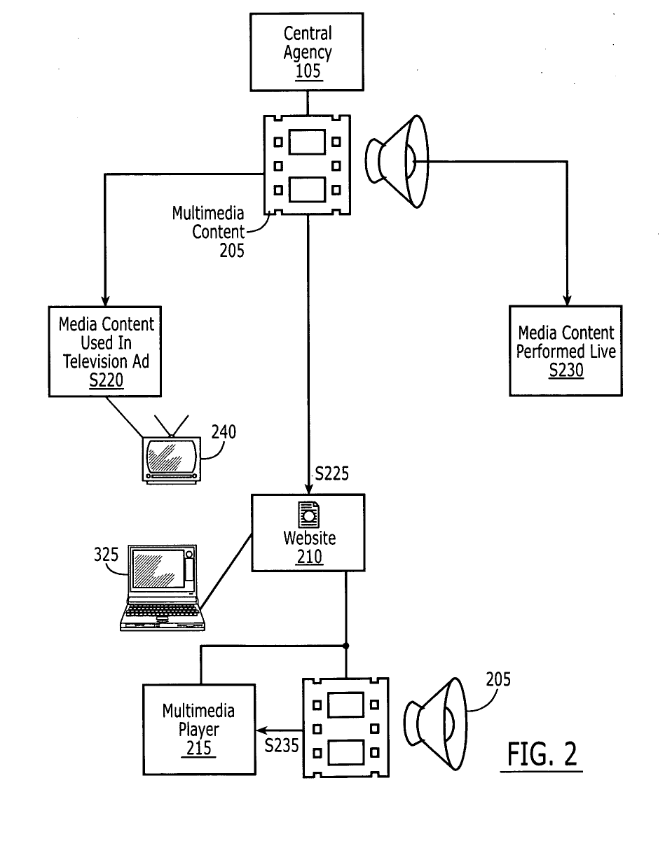

FIG. 2 is a diagram illustrating aspects of the distribution of multimedia content that may be implemented within embodiments of the present invention.

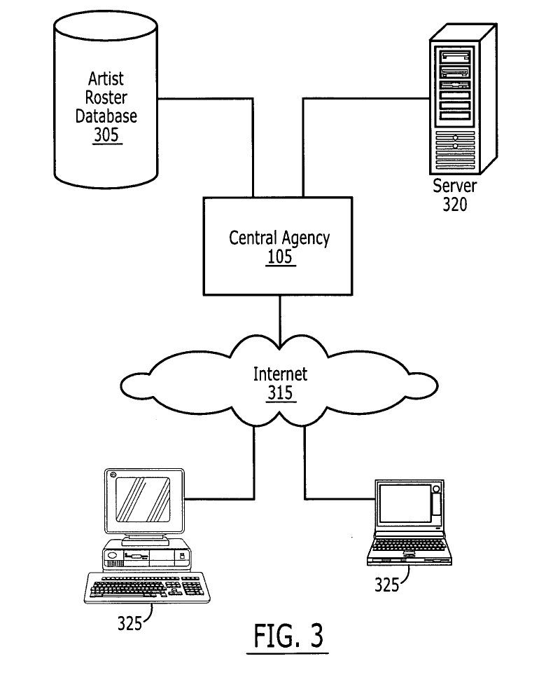

FIG. 3 is a diagram illustrating a central agency as embodied in aspects of the present invention.

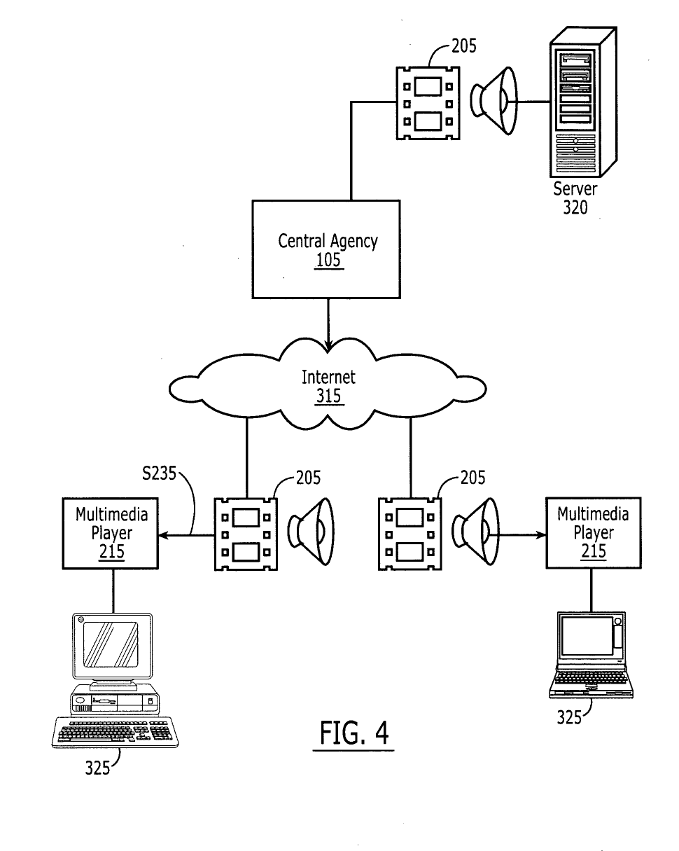

FIG. 4 is a diagram illustrating an aspect of the present invention wherein multimedia content is streamed to a multimedia player.

### DETAILED DESCRIPTION

One or more exemplary embodiments of the invention are described below in detail. The disclosed embodiments are intended to be illustrative only since numerous modifications and variations therein will be apparent to those of ordinary skill in the art. In reference to the drawings, like numbers indicate like parts continuously throughout the views.

The present invention is initially described in reference to FIG. 1. The foundation of the present methodology and system is a process that results in a mutually beneficial relationship or association between a corporation (first party 110) and an artist or entertainer, such as a musician, band or similar group (the second party 115). As illustrated in FIG. 1, a central agency or central system 105 facilitates many of the tasks associated with the multi-platform advertisement program.

As mentioned above, the central agency 105 facilitates the tasks and decisions that are associated with the multi-platform multimedia advertisement system of the present invention. The central agency 105 is accessed or used by interested parties in various ways. In aspects of the present invention artists apply to be listed on an available artist roster that is maintained in an artist database 305 by the central agency 105 (FIG. 3). Corporations are also able to apply to the central agency 105 in order to be paired with an appropriate artist with which the corporation is permitted to enter into an advertising relationship.

As illustrated in FIG. 3, corporations and artists apply and register with the central agency 105 at a computer 325 via the Internet 315 at a secure Internet access portal that is maintained by the central agency 105 at the server 320. The central agency 105 is responsible for establishing the criteria that are required for an artist to be accepted and subsequently listed on the available artists roster that is maintained by the central agency in the database 305.

A company, or first party 110, presents their advertisement business goals, the goals including whom the target audience is that they desire their advertisement to reach, to the central agency 105. As illustrated in FIG. 1 at step 120, the central agency 105 selects a group of artists (second parties 115) from an available roster listing and presents them to the corporation (first party 110) for their review. Once an artist (second party 115) is chosen, they enter into a partnership agreement with the company (first party 110). The central agency 105 then supervises the aspects to put an advertisement-marketing program into motion.

The partnership agreement between the artist (second party 115) and the company (first party 110) is preferably worked out in detail by the central agency 105 and agreed on by both the company and the artist (first and second parties 110 and 115). Items defined include, but are not limited to, the length of the partnership, the amount of promotional materials the artist has to produce, and the level of touring to be done by the artist.

As further illustrated in FIG. 1, aspects of the present invention provide a method for associating parties for an advertising relationship by the central agency 105. The method comprises the steps of determining a first party 110 to an advertising relationship. In this instance, the determination of a first party 110 entails the identification of a corporate entity that wishes to engage in a mutually exclusive advertising relationship with an artist or second party 115. Next, the central agency 105 at step 120 identifies a plurality of potential second parties 115 with which the first party 110 may wish to enter into an advertising relationship.

At step 125, the central agency 105 determines an appropriate second party 115 (in some instances more than one party may be selected) from the plurality of potential second parties that were identified at step 120. At step 130, the first party 110 is associated with the potential second party 115. At this step, the parties enter into a mutually exclusive agreement as facilitated with the assistance of the central agency 105. As part of the agreement, at step 135, the second party 115 creates a plurality of multimedia content 205 (FIG. 2) that is subsequently used by the first party 110 for advertisement purposes. The multimedia content 205 preferably comprises an audio performance by the second party 115 or a video recording of the audio performance of the second party 115.

The multimedia content 205 is thereafter associated with the first party 110 and distributed utilizing a multiplatform advertisement approach; this aspect will be discussed in greater detail below. The association of the multimedia content with the first party 110 preferably comprises the specific branding of the multimedia content 205 with the brand, trademark, logo or name of the first party 110. The association between the first party 110 and the multimedia content 205 is further made by having the multimedia content 205 be specifically created to reference the first party 110 in the substance of the multimedia content 205 materials.

As illustrated in FIG. 2 the advertisement marketing methodology comprises three main advertisement components. These components are advertising via television (broadcast, cable, satellite), online advertising (Internet), and live promotional activities.

Television Advertisement

As shown in FIGS. 1 and 2, aspects of the present invention comprise a method for associating parties for an advertising relationship, wherein the step 145 of distributing the multimedia content 205 comprises utilizing the multimedia content 205 in a television advertisement that is associated with the first party 110 and subsequently broadcast on television 240. This aspect of the present process encompasses traditional advertising techniques. The second party 115 (the artist) records songs that are used in the first party's 110 (i.e., the corporation's) television commercials. The central agency 105 is responsible for arranging the recording sessions including, but not limited to, studio time, producers, additional musicians (as needed), and mastering. As needed, the second party 115 appears in the television commercials that have been associated with the first party 110.

While this aspect of the method utilizes traditional media outlets, it goes beyond the limited reach of the conventional advertisement programs. The television ads provide the opportunity for consumers to hear and see the second party 115 (the artist) and associate them with the brand of the first party 110 (the corporation). Therefore, whenever the artist is seen in a television advertisement, this facilitates the solidification of the brand impression.

Online Advertisement

As illustrated in FIG. 2, within additional aspects of the present invention the step 145 of distributing the multimedia content 205 comprises distributing the multimedia content 205 via an interactive website 210 that is associated with the first party 110 and the second party 115 that is accessed via a conventional computing system 325. The interactive website 210 comprises a downloadable multimedia player 215, the downloadable multimedia player 215 being associated with the first party 110. The association between the first party 110 and the multimedia player 215 can comprise having the multimedia player prominently display the name or logo of the first party 110.

Additional aspects of the present invention provide for the multimedia content 205 that was created by the second party 115 to be configured to play back only and exclusively on the downloadable multimedia player 215 that is associated with the first party 110. In order to ensure proprietary rights in regard to the multimedia content 205 that is featured on an interactive website 210, the content will stream from the website 210 to the multimedia player 215 (FIG. 4, step 235).

The central agency 105 is preferably responsible for producing an interactive, co-branded website representing the first party 110 (the company) and the second party 115 (the artist). The interactive website 210 is designed as the artist's website, but will bear the brand of the corporation or it may it may be a co-branded neutral website. Information is available on the website 210, such as the artist's biography, photos, and tour dates. Further, a hyperlink is provided that links the artist's website to the corporation's website, and vice versa.

As mentioned above, one component of the present advertising marketing system is the downloadable, branded multimedia player 215 that is available on the interactive website 210. This is an application that is provided free of charge to visitors at the website 210. The player is configured to play rare tracks from the artist, preview new audio and visual materials, and provide multimedia content 205 comprising live recordings of the artist. To drive traffic, such ‘information’ and songs is exclusively available only at the co-branded or first party 110 branded website. Further, these songs can only be accessed via the multimedia player 215. The multimedia content 205 is preferably streamed from a server 320 that is maintained by the central agency 105 (FIG. 4). Site 210 visitors receive access to download the multimedia player 215 by registering at the interactive website 210. Thereafter, the visitor can send the multimedia player 215 directly to their friends or provide them the link to download the multimedia player 215. This is the basis for an integrated viral marketing advertisement campaign. Whenever a website 210 visitor accesses the multimedia content 205, they get impressions from both the artist and the associated company.

Additional aspects of the present invention provide for an online store to be featured at the interactive website 210, wherein visitors to the website 210 are able to purchase any of the multimedia content 205 that they have accessed. The available multimedia selections consist of content that is different than the content streamed to the branded multimedia player 215. Multimedia content can be purchased for download or as a CD or DVD that is shipped by conventional delivery methods to the customer. Again, such exclusive content drives demand and further multiplies the marketing and advertising effects of this system.

As mentioned above, registration will be required to download the multimedia player 215 and/or shop the online store. This aspect is important to measuring and determining the success of the advertisement and the use of the interactive website 210 for customer research. As visitors come to the site, a range of information is captured including, but not limited to, where they came to the site from, what pages they have viewed, and what offsite locations they click accessed. All of this information is valuable for showing the number of impressions that are being made as well as understanding in what content the visitors are most interested. This information is general (i.e., it is not tied to specific visitor). When a visitor registers, they provide more information about themselves, which provides a way to learn more about the consumers and how to market specifically to them. A visitor is also able to opt-in to receive other information like special offers from the associated company and to participate in research, such as surveys. All of the general and specific statistics, including the number or purchases of merchandise and downloads of the branded player are accessible to the associated company and the artist in a secure, customized web-based application preferably supplied by the central agency 105.

Live Promotional Activities

Further illustrated in FIG. 2, aspects of the present invention provide a method for associating parties for an advertising relationship wherein the step 145 of distributing media content 205 comprises the step of the second party 115 performing the content of the media content 205 in a live performance (step 230). Whereas televised and online advertisement aspects of the present invention showcase the artist and the branded company via traditional media and via contemporary Internet portals that a website 210 visitor can access, the live promotional activity aspect of the present invention is focused on the live advertised promotion of the associated multimedia content 205. Under the sponsorship of the corporation, the musical act takes their show to venues presenting their created multimedia content 205 or performing the content of their created multimedia content 205 in a live venue.

The central agency 105 preferably bears the responsibility for taking care of tour arrangements including, but not limited to, booking venues, arranging accommodations, and securing transportation. Additional advertising impressions are preferably integrated into the performances by way of merchandise, concessions, and customs booths. Keeping with the concept of each aspect of the components of the present invention supporting one another, all of the performances are recorded in order to create new multimedia content 205. The resulting material is the usable on the website as content for the branded player, downloads for registered users, merchandise for sale in online, and physical stores.

This new marketing system and methodology considers a wide range of factors and provides solutions and benefits for both the corporation and the artist. The present advertising marketing strategy is designed to generate a multitude of impressions across a wide range of media. The artist/corporation brand combination is displayed on television, on handheld devices, at venues, online, and more. Much of this visibility is measurable as website activity, downloads, and concert attendance. As new devices are created, the media carrying the company's message will adapt to work with them.

Each component of the present invention promotes the other. The television advertisements directs viewers to the website. The website provides live performance information. At the live performances, music from the television advertisements is performed. There are many variations in the approach. All of the activity adds up to more diversified corporate brand promotion.

The central agency 105 is the facilitator for the partnership between the corporation and the artist. Instead of working to protect the interests of just the corporation or just the artist, it is a partner to both. The central agency 105 works to make sure the program is successful. Since the central agency 105 streamlines the process, it is able to keep costs down, which is beneficial to everyone. The central agency's 105 involvement is important throughout the life of the campaign. In the earliest stages, the central agency 105 screens acts in order to make sure that they are compatible with the corporation's standards. It also reviews what the target audience is and select recommendations to target the correct group. As data is collected, the central agency 105 analyzes it to make suggestions regarding how to market further to the consumers and to report the effectiveness of the program.

A yet further aspect of the present invention comprises a method for associating parties for an advertising relationship by a central agency 105, wherein the method comprising the steps of determining a first party to an advertising relationship and identifying a plurality of potential second parties 115 to engage in an advertising relationship with the first party 110. The central agency 105 determines a second party 115 to enter into an advertising relationship with the first party 110 from the plurality of potential second parties and thereafter associates the first party 110 with the potential second party 115.

As a result of entering into the relationship with the first party 110, the second party 115 creates a plurality of multimedia content 205, wherein the multimedia content 205 comprises audio and video multimedia content. The central agency 105 associates the multimedia content 205 created by the second party 115 with the first party 110 and thereafter distributes the associated multimedia content 205.

An aspect of the present method comprises the step of utilizing the multimedia content 205 in a television advertisement that is associated with the first party 110. Further aspects of the present method provide for distributing the media content via an interactive website 210 that is associated with the first party 110 and the second party 115. Further, the interactive website 210 can comprises a downloadable media player, wherein the downloadable multimedia player is associated with the first party 110. The multimedia content 205 that was created , by the second party 115 is configured to be played back exclusively on the downloadable multimedia player 215 that is associated with the first party 110, the multimedia content 205 being streamed from a server 320 to the multimedia player 215. A yet additional aspect of the present method comprises the second party 115 performing the content of the multimedia content 205 in a live performance.

The corporation (first party 110), the artist (second party 115), and the central agency 105 all have their roles within this novel methodology and system. The overarching vision is to reach an audience in a way that is more effective than presently used methods and systems. The focus on digital as the media, the use of music as a primary way to communicate the brand identity, and the multifaceted approach of delivering impressions all make this system unique and valuable to the world of advertisement.

Therefore, it will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for associating parties for an advertising relationship by a central agency, the method comprising the steps of:
determining a first party to an advertising relationship;
identifying a plurality of potential second parties;
determining a second party to an advertising relationship from a plurality of potential second parties;
associating the first party with at least one of the potential second parties;
the second party creating a plurality of multimedia content;
associating the multimedia content created by the second party with the first party;
distributing the associated multimedia content.

2. The method for associating parties for an advertising relationship of claim 1, wherein the step of distributing the multimedia content comprises utilizing the multimedia content in a television advertisement that is associated with the first party.

3. The method for associating parties for an advertising relationship of claim 1, wherein the multimedia content comprises an audio recording of a performance by the second party.

4. The method for associating parties for an advertising relationship of claim 1, wherein the multimedia content comprises a video recording of a performance by the second party.

5. The method for associating parties for an advertising relationship of claim 1, wherein the step of distributing the multimedia content comprises distributing the multimedia content via an interactive website that is associated with the first party and the second party.

6. The method for associating parties for an advertising relationship of claim 5, wherein the interactive website comprises a downloadable multimedia player, the downloadable multimedia player being associated with the first party.

7. The method for associating parties for an advertising relationship of claim 6, wherein the multimedia content created by the second party is configured to be played back exclusively on the downloadable multimedia player that is associated with the first party.

8. The method for associating parties for an advertising relationship of claim 7, wherein the multimedia content is streamed to the downloadable multimedia player.

9. The method for associating parties for an advertising relationship of claim 1, wherein the multimedia content comprises an audio recording of a performance by the second party.

10. The method for associating parties for an advertising relationship of claim 1, wherein the multimedia content comprises a video recording of a performance by the second party.

11. The method for associating parties for an advertising relationship of claim 1, wherein the step of distributing the multimedia content comprises the step of the second party performing the content of the multimedia content in a live performance.

12. A method for associating parties for an advertising relationship by a central agency, the method comprising the steps of:
determining a first party to an advertising relationship;
identifying a plurality of potential second parties;
determining a second party to an advertising relationship from a plurality of potential second parties;
associating the first party with at least one of the potential second parties;
the second party creating a plurality of multimedia content, wherein the multimedia content comprises audio and video multimedia content;
associating the multimedia content created by the second party with the first party;
distributing the associated multimedia content.

13. The method for associating parties for an advertising relationship of claim 12, wherein the step of distributing the multimedia content comprises utilizing the multimedia content in a television advertisement that is associated with the first party.

14. The method for associating parties for an advertising relationship of claim 13, wherein the step of distributing the multimedia content comprises distributing the multimedia content via an interactive website that is associated with the first party and the second party.

15. The method for associating parties for an advertising relationship of claim 14, wherein the interactive website comprises a downloadable multimedia player, the downloadable multimedia player being associated with the first party.

16. The method for associating parties for an advertising relationship of claim 15, wherein the multimedia content created by the second party is configured to be played back exclusively on the downloadable multimedia player that is associated with the first party.

17. The method for associating parties for an advertising relationship of claim 16, wherein the multimedia content is streamed to the downloadable multimedia player.

18. The method for associating parties for an advertising relationship of claim 17, wherein the interactive website is accessed via a wireless device.

19. The method for associating parties for an advertising relationship of claim 1, wherein the step of distributing the multimedia content comprises the step of the second party performing the content of the multimedia content in a live performance.

20. A method for associating parties for an advertising relationship by a central agency, the method comprising the steps of:
determining a first party to an advertising relationship;
identifying a plurality of potential second parties;
maintaining a listing of the plurality of potential second parties in a database;
determining a second party to an advertising relationship from a plurality of potential second parties;
associating the first party with at least one of the potential second parties;
the second party creating a plurality of multimedia content, wherein the multimedia content comprises audio and video multimedia content;
associating the multimedia content created by the second party with the first party;
distributing the associated multimedia content.
